(19) United States
(12) Patent Application Publication
(10) Pub. No.: US 2002/0157317 A1
(43) Pub. Date: Oct. 31, 2002

(54) AUTOMATIC DOOR ASSEMBLY INCLUDING A BRAKING MECHANISM.

(75) Inventors: Gilbert Valencia, Hoffman Estates, IL (US); Kevin Bailey, Morris, IL (US)

Correspondence Address: Don W. Walk, Michael Best & Friedrich LLP, 942 Memorial Parkway, Phillipsburg, NJ, 08865-2726, US

(73) Assignee: Dor-O-Matic, Inc., Harwood Heights, IL

(21) Appl. No.: 09/842,739

(22) Filed: Apr. 25, 2001

(51) Int. Cl. E05F 11/00

(52) U.S. Cl. 49/360; 49/366; 49/370

(57) ABSTRACT

An automatic door assembly including a sliding door and an electric motor drivingly coupled to the sliding door. The electric motor includes a clutch movable between a locked position preventing rotation of the electric motor and an unlocked position permitting rotation of the electric motor.

### BACKGROUND AND SUMMARY OF THE INVENTION

The present invention relates to an assembly of automatic doors which open and close in response to input from sensors associated with the door assembly. More particularly, the invention relates to an assembly of sliding automatic doors which are opened and closed by a belt drive.

Conventional sliding automatic door assemblies are typically programmed to automatically open and close in response to a variety of circumstances. The doors automatically open or close in response to signals from various sensors associated with the door assembly. Typically, the doors of a conventional automatic sliding door assembly can be manually opened from their closed position, even in circumstances where the doors are not programmed to open. This is because the drive mechanism of a typical automatic door assembly can be overcome by manual force. In other words, even where the assembly is programmed to close the doors in response to a particular set of circumstances, the doors can be manually forced open. To secure the doors from being slid open manually, a locking mechanism is used which includes a pin inserted into the frame of the sliding doors. Such pin locking mechanisms consume substantial space in the header above typical sliding doors and add significant expense to the entire automatic door assembly. An automatic door assembly which locks the doors in their closed position without the addition of a locking pin mechanism would be welcomed by users of automatic door assemblies.

According to the present invention, an automatic door assembly includes a sliding door and an electric motor drivingly coupled to the sliding door and including a clutch movable between a locked position preventing rotation of the electric motor and an unlocked position permitting rotation of the electric motor.

In preferred embodiments, the door assembly includes a pair of sliding doors and a cogwheel is coupled to the electric motor. The cogwheel and a tensioner wheel are positioned a distance apart from each other across the top of the pair of sliding doors. Around the cogwheel and tensioner is wrapped a drive belt that circulates as the cogwheel turns. The belt runs in a continuous loop around the cogwheel and tensioner wheel. Therefore, as the belt circulates, an upper portion of the belt moves in one direction, while a lower portion of the belt moves in the opposite direction. One of the pair of sliding doors is attached to the upper portion of the belt, while the other sliding door is attached to the lower portion of the belt. Thus, as the belt circulates, the sliding doors move in opposite directions. Additionally, the cogwheel and tensioner wheel are toothed and engage ribs on the belt, ensuring that the belt cannot slip around the cogwheel or tensioner wheel.

The clutch moves between an unlocked position permitting the electric motor and the cogwheel to rotate and a locked position preventing the electric motor and cogwheel from rotating. In its locked position, the clutch not only prevents rotation of the electric motor and cogwheel, but also prevents circulation of the belt, which, as mentioned, includes ribs that engage teeth on the cogwheel. In this way, with the clutch in its locked position, the sliding doors attached to the belt cannot be manually forced open.

Additional features and advantages of the invention will become apparent to those skilled in the art upon consideration of the following detailed description of preferred embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a door assembly in accordance with the present invention showing a pair of sliding doors connected to a belt driven by an electric motor including a clutch;

FIG. 1A is a magnified view of a key panel mounted on a frame of the door assembly to control the functionality of the door assembly; and

FIG. 2 is a perspective view of the electric motor and drive belt.

### DETAILED DESCRIPTION OF THE DRAWINGS

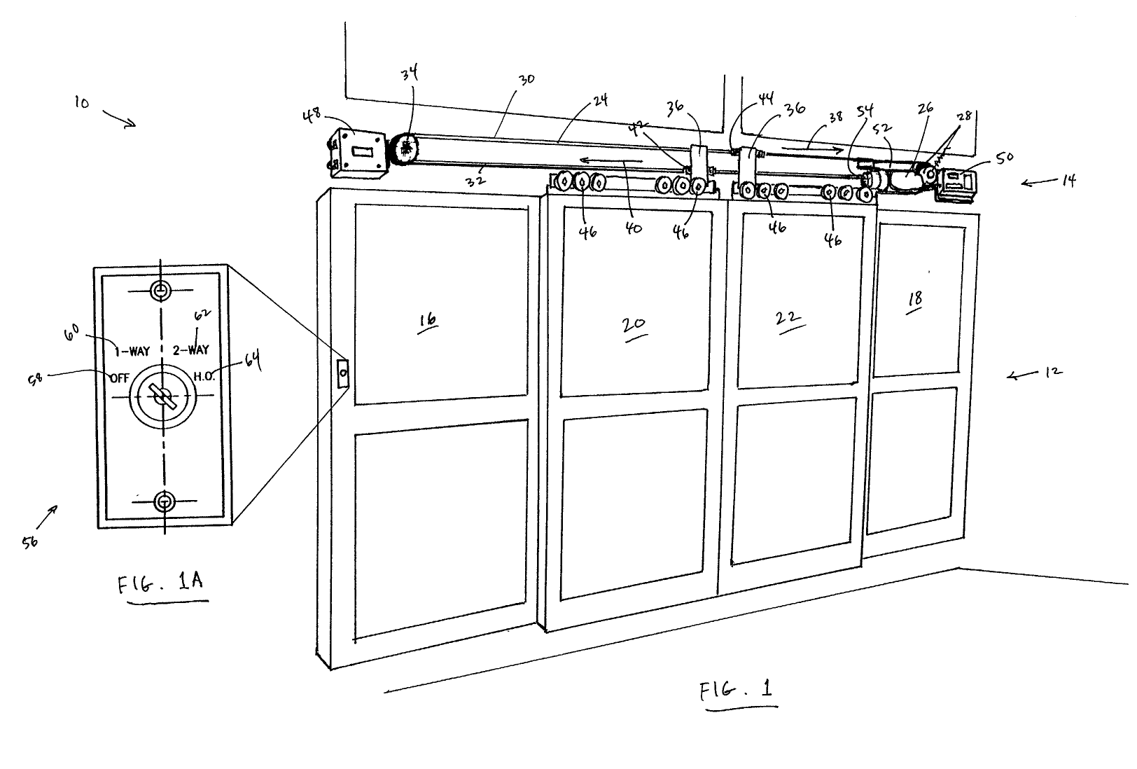

Referring to FIGS. 1 and 1A, an automatic door assembly 10 in accordance with the present invention comprises a set of sliding doors 12 and a drive mechanism 14. The set of sliding doors 12 includes a first and second fixed panel 16, 18 and a first and second sliding panel 20, 22. The first and second sliding panels 20, 22 are movable between a closed position, as shown in FIG. 1, and an opened position, wherein the first sliding panel 20 overlaps the first fixed panel 16 and the second sliding panel 22 overlaps the second fixed panel 18.

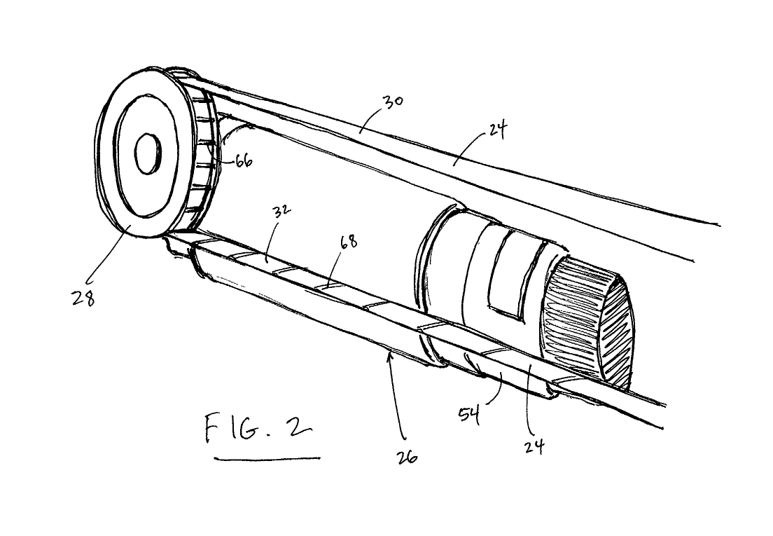

The first and second sliding panels 20, 22 are driven by the drive mechanism 14. Specifically, the first and second sliding panels 20, 22 move in response to circulation of a belt 24, to which they are attached. The belt 24 extends around a cogwheel 28 driven by an electric motor 26. As best seen in FIG. 2, the cogwheel 28 includes teeth 66 that provide a secure engagement with ribs 68 on the belt 24. Referring again to FIG. 1, the belt 24 forms a continuous loop, including an upper portion 30 and a lower portion 32, which extend between the cogwheel 28 on one end and a tensioner pulley 34 on the other end. The electric motor 26 is preferably reversible so that the cogwheel 28 can be driven clockwise or counterclockwise. In this way, the belt 24 can also be driven in either a clockwise or counterclockwise direction around the cogwheel 28 and the tensioner pulley 24.

In a preferred embodiment, the first sliding panel 20 is coupled to the lower portion 32 of the belt 24 by a connector 36 and the second sliding panel 22 is coupled to the upper portion 30 of the belt 24 by another connector 36. As will be readily apparent to one of ordinary skill in the art, given this arrangement, as the belt 24 is driven around the cogwheel 28 and the tensioner pulley 34, the first and second sliding panels 20, 22 move in opposite directions. For example, if the cogwheel 28 is driven in a clockwise direction in FIG. 1, the upper portion 30 of the belt 24 moves in a direction 38 to the right. At the same time, the lower portion 32 of the belt 24 moves in a direction 40 to the left. Because the first sliding panel 20 is coupled to the lower portion 32 of the belt 24 at connection point 42, it will also move in direction 40. Similarly, because the second sliding panel 22 is coupled to the upper portion 30 of the belt 24 at a connection point 44 it will move in direction 38. As will be readily understood by one of ordinary skill in the art, as the cogwheel 28 is rotated in a clockwise direction, the first and second sliding panels 20, 22 will separate. The first sliding panel 20 will move into a position overlapping the first fixed panel 16 and the second sliding panel 22 will move into a position overlapping the second fixed panel 18. The first and second sliding panels 20, 22 employ rollers 46 to facilitate this opening motion. The electric motor 26 can be reversed, thus reversing the motion of the belt 24, to return the first and second sliding panels 20, 22 to their closed position, as shown in FIG. 1.

The drive mechanism 14 further includes a transformer 48, which provides power to the electric motor 26, and a main controller 50 and a clutch-drive circuit 52, which control the functionality of the automatic door assembly 10 as will be more fully discussed below.

The electric motor 26 includes a clutch 54 that acts as a lock for the motor 26. An example of an electric motor that employees such a locking clutch is Dunkermotoren model GR63X55. With the clutch 54 in a locked position, the motor 26, and thus the cogwheel 28, cannot be rotated. With the clutch 54 in its unlocked state, the electric motor 26 and the cogwheel 28 can rotate freely. According to one embodiment of the present invention as shown in FIG. 1, if the clutch 54 is in its unlocked state, the first and second sliding panels 20, 22 can be manually slid apart because the belt 24 and the cogwheel 28 are free to rotate. However, if the clutch 54 is in its locked state, the electric motor 26 and the cogwheel 28 are locked down and cannot rotate. Additionally, the cogwheel's teeth 66 provide resistance against the belt's ribs 68, so the belt 24 is also prevented from moving. Thus, the first and second sliding panels 20, 22, which are attached to the belt 24, cannot be manually slid apart.

The electric motor 26 and its clutch 54 provide users of the automatic door assembly 10 according to the present invention with various functional modalities. For example, when the first and second sliding panels 20, 22 are in their closed position, the clutch 54 can be programmed to lock down the electric motor 26, thereby preventing manual separation of the first and second sliding panels 20, 22. If manual separation of the first and second sliding panels 20, 22 is desired, the clutch 54 can be programmed to unlock the electric motor 26 when the panels 20, 22 are in their closed position. As will be readily understood by one of ordinary skill in the art, locking and unlocking the clutch 54, and thereby the electric motor 26, can provide various functional modalities of the automatic door assembly 10 in addition to those described herein. A user of the assembly 10 can dictate in what circumstances it is desired to lock or unlock the panels 20, 22 and program the assembly 10, and in particular the clutch 54, accordingly.

The functioning of the electric motor 26 and its clutch 54 are controlled by the main controller 50. The main controller 50 receives signals from various sensors (not shown) associated with the automatic door assembly 10, as will be readily understood by one of ordinary skill in the art. The sensors send signals to the main controller 50 providing information regarding the environment surrounding the automatic door assembly 10. For example, the sensors may include motion sensors that detect the presence of a person approaching the automatic door assembly 10. The sensors may include any of a number of devices known in the art, such as motion detectors, presence sensors, and photo beam sensors, etc. The main controller 50 takes the signals from the sensors, processes them, and sends appropriate signals to the clutch-drive circuit 52 according to the desired functional modality programmed by a user of the assembly 10. The clutch-drive circuit 52 then appropriately signals the clutch 54 to lock or unlock according to the prescribed functional modality.

For example, if a user of the assembly 10 wants the first and second sliding panels 20, 22 to be permitted to be manually slid open by a person approaching the assembly 10, the clutch-drive circuit 52 can be programmed to appropriately control the clutch 54 to unlock the electric motor 26. If a user does not want the sliding panels 20, 22 to be permitted to be manually slid open in the same set of circumstances, the clutch-drive circuit 52 can be programmed to control the clutch 54 to lock the electric motor 26. Whatever functionality is desired for the assembly 10, the main controller 50 and clutchdrive circuit 52 can be programmed to control the operation of the first and second sliding panels 20, 22 accordingly, including whether they are locked or unlocked by the clutch 54.

One of ordinary skill in the art will understand that the assembly 10 can be programmed to function in a variety of ways depending on a number of possible circumstances. As one of many possible functional modalities, the clutch-drive circuit 52 can be programmed for “fail-safe” or “fail-secure” operation. “Fail-safe” indicates that the clutch 54 unlocks and allows the first and second sliding panels 20, 22 to be manually operated in the event of a power failure to the drive mechanism 14. “Fail-secure” indicates that the clutch locks and prevents manually operation of the first and second sliding panels 20, 22 in the event of a power failure.

According to one embodiment of the present invention as shown in FIGS. 1 and 1A, the functionality of the automatic door assembly 10 is set using a key panel 56. The key panel 56 provides for four functional modalities: an “OFF” mode 58, a “1-WAY” mode 60, a “2-WAY” mode 62, and an “H.O.” or “hold open” mode 64. Each of these four modes provides different functionality for the automatic door assembly 10.

First, if the key panel 56 is set in the “OFF” mode 58, the first and second sliding panels 20, 22 will close and the clutch 54 will lock down the electric motor 26 so that the first and second sliding panels 20, 22 cannot be manually slid apart.

Second, if the key panel 56 is set in the “1-WAY” mode 60, the first and second sliding panels 20, 22 will open in response to a person approaching the automatic door assembly 10 from one side, but not the other. In this mode, the clutch 54 locks down the electric motor 26 when the first and second sliding panels 20, 22 are closed, preventing the panels 20, 22 from being slid apart. However, a sensor or sensors (e.g. inside motion detectors or microwave sensors and presence sensors, not shown) are positioned to detect an approaching person from one side of the automatic door assembly 10 (or to detect other circumstances in which it is desired to open the panels 20, 22) and direct the drive mechanism 14 to open the panels 20, 22. The sensor(s) transmits a signal(s) to the main controller 50, which interprets the signal(s) and directs the clutch-drive circuit 52 to appropriately unlock the electric motor 26 and open the sliding panels 20, 22. If a person approaches the automatic door assembly 10 from the other side, there is no signal sent to the clutch-drive circuit 52 via the main controller 50 and the clutch 54 remains locked and the panels 20, 22 remain closed. Further, as mentioned, the clutch 54 is programmed to lock the electric motor 26 when the panels 20, 22 are closed. Therefore, a person approaching the automatic door assembly 10 cannot manually slide apart the first and second sliding panels 20, 22.

Third, with the key panel 56 set in the “2-WAY” mode 62, appropriate sensors (not shown), the main controller 50, and the clutch-drive circuit 52 are configured and programmed to open the first and second sliding panels 20, 22 in response to the presence of a person approaching the automatic door assembly 10 from either side. In this mode, because it is desired to open the sliding panels 20, 22 in response to an approaching person from either side, it is not necessary to lock the panels 20, 22 in their closed position. Therefore, in a preferred embodiment, the clutch-drive circuit 52 controls the clutch 54 to remain unlocked. In this way, not only do the panels 20, 22 appropriately open in response to signals from the sensors, but the first and second sliding panels 20, 22 can be manually opened. However, if it is desired to only permit the panels 20, 22 to open in response to appropriate signals from the sensors (and not manually), the clutch-drive circuit 52 can be programmed to lock the clutch 54 when the panels 20, 22 are closed. In this way, the panels 20, 22 will still open in response to appropriate signals, but a person cannot manually separate the sliding panels 20, 22 by forcing the belt 24 in a clockwise motion around the cogwheel 28. If the clutch 54 is programmed to lock when the panels 20, 22 are closed, the panels 20, 22 cannot be manually be opened because the cogwheel 28 cannot rotate.

Fourth, with the key panel 56 set in the “H.O.” or “hold open” mode 64, the first and second sliding panels 20, 22 are moved to their opened position overlapping the first and second fixed panels 16 and 18, respectively. In this mode, the clutch-drive circuit 52 signals the clutch 54 to unlock the electric motor 26 permitting the first and second sliding panels 20, 22 to be manually moved.

In each of the above-described modes, the clutch 54 locks or unlocks the electric motor 26 based on the functionality desired for the automatic door assembly 10. In other words, if a user of the automatic door assembly 10 desires the first and second sliding panels 20, 22 to be locked in certain circumstances (i.e., preventing a person from manually moving the sliding panels 20, 22), he or she can do so.

This can be illustrated with further reference to the four functional modalities indicated on the key panel 56 shown in FIGS. 1 and 1A. With the key panel 56 set in the “OFF” mode 58, according to a preferred embodiment of the present invention as described above, the clutch 54 locks down the electric motor 26. According to a preferred embodiment, for security reasons it is desired that the panels 20, 22 not be permitted to be manually slid apart when the assembly 10 is set in the “OFF” mode 58. However, according to another embodiment of the present invention, it may be desired to permit the sliding panels 20, 22 to be manually slid opened when the assembly 10 is set in the “OFF” mode 58. In an alternative embodiment, the clutch-drive circuit 52 is programmed to direct the clutch 54 to unlock when the key panel 56 is set to the “OFF” mode 58.

Similarly, according to a preferred embodiment of the present invention as described above, with the assembly 10 set in the “1-WAY” mode 60, it is desired that the first and second sliding panels 20, 22 open in response to a person approaching from one side of the automatic door assembly 10, but it is not desired to permit the first and second sliding panels 20, 22 to be manually moved. Otherwise, a person approaching the automatic door assembly 10 from a second side would be able to manually open the sliding panels 20, 22 and pass through the assembly 10. Therefore, the drive mechanism 14 is programmed so that the clutch 54 locks the motor 26 when the sliding panels 20, 22 are closed and the key panel 56 is set in the “1-WAY” mode 60. The clutch 54 will only unlock in response to proper signals transmitted via the clutch-drive circuit 52. However, in an alternative embodiment of the present invention, it may be desirable to unlock the clutch 54 when the assembly is functioning in the “1-WAY” mode 60. In this case the main controller 50 and clutch-drive circuit 52 are simply programmed accordingly.

According to a preferred embodiment of the present invention, with the automatic door assembly 10 functioning in the “2-WAY” mode 62, allowing the first and second sliding panels 20, 22 to be manually moved is not a concern because it is desired to allow passage of a person through the automatic door assembly 10 from either side. Therefore, the clutch-drive circuit 52 is programmed to unlock the motor 26 and permit the manual movement of the panels 20, 22, the belt 24, and the cogwheel 28. Similarly, with the automatic door assembly 10 functioning in the “H.O.” or “hold open” mode 64, passage of a person through the automatic door assembly 10 from either side of the assembly 10 is not a concern and the clutch 54 is programmed to remain in its unlocked position. However, according to alternative embodiments of the present invention, in both the “2-WAY” and “H.O.” modes, the assembly 10 can be programmed to direct the clutch 54 to lock the motor 26 so that the panels 20, 22 cannot be moved manually.

The above-described preferred embodiment represents a particular programmed functional modality for the automatic door assembly 10 according to the present invention. The described alternative embodiments represent other functional modalities for the automatic door assembly 10 according to the present invention. In each case, the functional modalities described represent different options that relate to the four modes indicated on the key panel 56. However, in addition to options associated with the modes indicated on the key panel 56, it will be understood by one of ordinary skill in the art that functional modalities can be programmed into the drive mechanism 14 that may pertain to modes other than those indicated on the key panel 56. There are a virtually limitless number of functional modalities (both those that might be described by the four modes indicated on the key panel 56 and those that would likely not be described by the modes indicated on the key panel 56) that can be configured for the automatic door assembly 10 according to the present invention. In each case, the clutch 54 is controlled to lock down the electric motor 26 in situations where manual movement of the sliding panels 20, 22 is not desired. One of ordinary skill in the art will understand that the clutch-drive circuit 52 and the main controller 50 can be appropriately programmed to process signals from a variety of input devices (e.g. push buttons, motion detectors, presence sensors, key panels, etc.) and open, close, lock, and unlock the sliding panels 20, 22 accordingly. Nothing described herein is intended to limit the invention to the functional modalities specifically outlined herein.

Although the invention has been described in detail with reference to certain preferred embodiments, variations and modifications exist within the scope and spirit of the invention as described and defined in the following claims.

1. An automatic door assembly, comprising:
a sliding door;
an electric motor drivingly coupled to the sliding door;
a clutch coupled to the electric motor, the clutch moveable between a locked position preventing rotation of the motor and an unlocked position permitting rotation of the motor; and
a clutch-drive circuit coupled to the clutch, the clutch-drive circuit controlling movement of the clutch between its locked and unlocked positions.

2. The automatic door assembly of claim 1, further comprising a sensor and a main controller, the main controller relaying signals from the sensor to the clutch-drive circuit.

3. The automatic door assembly of claim 2, further comprising a cogwheel coupled to the electric motor and a belt coupled between the cogwheel and the sliding door, the belt translating rotational motion of the cogwheel into linear motion of the sliding door.

4. An automatic door assembly, comprising:
a sliding door;
an electric motor coupled to the sliding door; and
a clutch moveable between a locked position preventing rotation of the electric motor and an unlocked position permitting rotation of the electric motor.

5. The automatic door assembly of claim 4, further comprising a clutch-drive circuit coupled to the clutch, the clutch-drive circuit controlling movement of the clutch between its locked and unlocked positions.

6. The automatic door assembly of claim 5, further comprising a cogwheel coupled to the motor and a belt coupled between the cogwheel and the sliding door, the belt translating rotational motion of the motor into linear motion of the sliding door.

7. The automatic door assembly of claim 6, further comprising a sensor coupled to the clutch-drive circuit, the sensor sending a signal to the clutch-drive circuit via a main controller.

8. An automatic door assembly, comprising:
a sliding door;
a belt coupled to the sliding door;
an electric motor having a cogwheel around which the belt extends;
a clutch coupled to the electric motor, the clutch moveable between a locked position preventing rotation of the electric motor and an unlocked position permitting rotation of the electric motor; and
a clutch-drive circuit sending signals to the clutch.

9. The automatic door assembly of claim 8, wherein the belt includes ribs and the cogwheel includes teeth that engage the ribs.

10. The automatic door assembly of claim 9, further including a sensor and a main controller, the sensor sending signals to the motor via the main controller and clutch-drive circuit.
